(19) United States
(12) Patent Application Publication
(10) Pub. No.: US 2006/0060151 A1
(43) Pub. Date: Mar. 23, 2006

(54) Dog kennel canopy system

(76) Inventor: Jeffrey M. Sullivan, Coleman, MI (US)

Correspondence Address: MCKELLAR IP LAW, PLLC, 784 SOUTH POSEYVILLE ROAD, MIDLAND, MI, 48640, US

(21) Appl. No.: 10/933,601

(22) Filed: Sep. 3, 2004

(51) Int. Cl. A01K 1/03

(52) U.S. Cl. 119/482

(57) ABSTRACT

An improved roof or canopy system for a dog kennel or the like of the type that includes substantially parallel spaced apart walls and substantially parallel spaced apart substantially horizontal pipe sections at or near the top of the spaced apart walls. The improvement relates to a tarp support structure consisting of: (a) a first flexible beam attached at the ends thereof to the substantially parallel spaced apart substantially horizontal pipe sections, the first flexible beam being bowed upward from the ends thereof under bending stress; (b) at least a second flexible beam attached at the ends thereof to the substantially parallel spaced apart substantially horizontal pipe sections, the second flexible beam being bowed upward from the ends thereof under bending stress, the second flexible beam being substantially parallel to and spaced apart from the first flexible beam; and (c) a ridge beam attached at one end thereof at or near the apex of the bow of the first flexible beam and at the other end thereof at or near the apex of the bow of the second flexible beam.

### BACKGROUND

The instant invention is in the field of dog kennels and more specifically the instant invention is in the field of roof or canopy systems for dog kennels.

In general, dog kennels are comprised of galvanized steel pipe frames supporting wire mesh panels, see, for example, U.S. Pat. No. 6,553,940. Roof or canopy systems for such kennels can comprise a tarp supported by a flat wire mesh panel (U.S. Pat. No. 5,845,432 and U.S. Pat. No. 4,819,582) or a flat corrugated panel supported at the edges thereof (U.S. Pat. No. 4,696,259) or an arched corrugated panel supported at the edges thereof (U.S. Pat. No. D219,277).

Prior roof or canopy systems for such kennels which consist of a flat roof or canopy provide excellent sun protection but have poor rain and snow shedding characteristics. Prior roof or canopy systems for such kennels which consist of an arched corrugated panel are relatively expensive and heavy. It would be an advance in the art of roof or canopy systems for such kennels if a canopy structure were developed that shed rain and snow better than a flat roof or canopy and which was relatively light, less expensive and easier to construct than an arched corrugated panel.

### SUMMARY OF THE INVENTION

The instant invention is a roof or canopy system for a dog kennel or the like that provides an arched support structure for a tarp. The arch shape of the resulting canopy sheds water or snow better than a flat canopy or panel. The roof or canopy system of the instant invention is relatively light, inexpensive and easy to construct as well as being relatively strong and tough.

More specifically, the instant invention is an improved roof or canopy system for a dog kennel or the like, the kennel comprising substantially parallel spaced apart walls, the kennel comprising substantially parallel spaced apart substantially horizontal pipe sections at or near the top of the spaced apart walls, wherein the improvement comprises: (a) a first flexible beam attached at the ends thereof to the substantially parallel spaced apart substantially horizontal pipe sections, the first flexible beam being bowed upward from the ends thereof under bending stress; (b) at least a second flexible beam attached at the ends thereof to the substantially parallel spaced apart substantially horizontal pipe sections, the second flexible beam being bowed upward from the ends thereof under bending stress, the second flexible beam being substantially parallel to and spaced apart from the first flexible beam; and (c) a ridge beam attached at one end thereof at or near the apex of the bow of the first flexible beam and at the other end thereof at or near the apex of the bow of the second flexible beam.

### BRIEF DESCRIPTION OF THE DRAWINGS

FIG. 1 is a perspective view of a conventional dog kennel comprising substantially parallel spaced apart walls of chain link fencing and substantially parallel spaced apart substantially horizontal pipe sections at or near the top of the spaced apart walls;

FIG. 2 is a perspective view of the substantially parallel spaced apart substantially horizontal pipe section portion of the kennel of FIG. 1, further showing the bowed beam and ridge beam structure of the instant invention;

FIG. 3 is a cross-sectional end view of the structure shown in FIG. 2;

FIG. 4 is an end view of a polyvinyl chloride tee pipe fitting that has been cut away to snap over a pipe;

FIG. 5 is a front view of the polyvinyl chloride tee pipe fitting of FIG. 4;

FIG. 6 is a perspective view of a dog kennel equipped with the tarp support structure of FIG. 2 supporting a tarp; and

FIG. 7 is a side cross-sectional view of a preferred means of protecting a tarp from chafing against the top of the chain link fence portion of the dog kennel of FIG. 6.

### DETAILED DESCRIPTION OF THE INVENTION

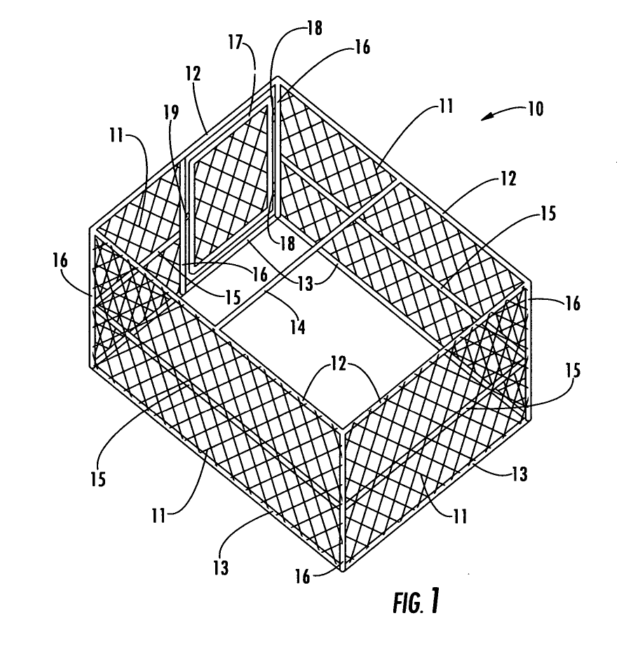

Referring now to FIG. 1, therein is shown a conventional dog kennel 10 comprising substantially parallel spaced apart walls 11 of chain link fencing. The kennel 10 comprises substantially parallel spaced apart substantially horizontal pipe sections 12 at or near the top of the spaced apart walls 11. The kennel 10 also comprises substantially parallel spaced apart substantially horizontal pipe sections 13 at or near the bottom of the spaced apart walls 11. The kennel 10 comprises a reinforcing pipe 14, mid level pipe sections 15 and vertical pipe sections 16. The kennel 10 also comprises a door 17 mounted on hinges 18 and equipped with a door latch 19. Ordinarily, the kennel 10 would be positioned on a concrete pad. Ordinarily, the kennel 10 will consist essentially of chain link fence components or the like.

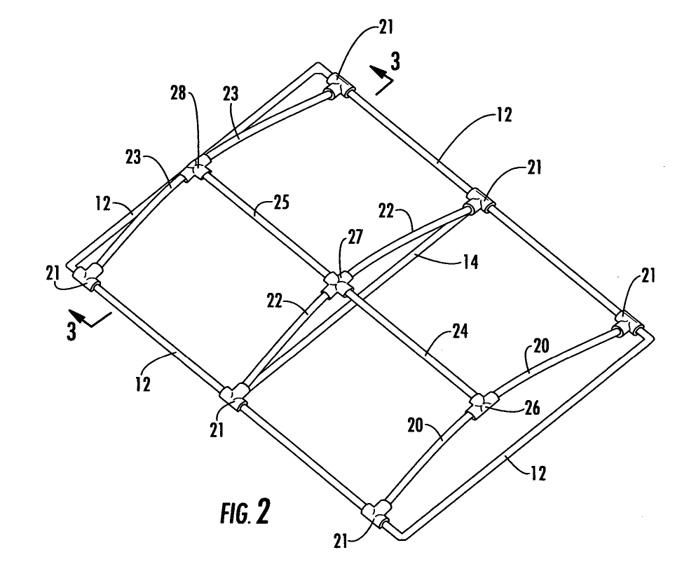

Referring now to FIG. 2, therein is shown a perspective view of the substantially parallel spaced apart substantially horizontal pipe sections 12 of the kennel of FIG. 1. A first flexible beam 20 of polyvinyl chloride pipe is attached at the ends thereof to the substantially parallel spaced apart substantially horizontal pipe sections 12 by way of specially adapted polyvinyl chloride tee pipe fittings 21 (which fittings will be discussed below in greater detail). The first flexible beam 20 is bowed upward from the ends thereof under bending stress. A second flexible beam 22 of polyvinyl chloride pipe is attached at the ends thereof to the substantially parallel spaced apart substantially horizontal pipe sections 12 by way of the specially adapted polyvinyl chloride tee pipe fittings 21. The second flexible beam 22 is bowed upward from the ends thereof under bending stress. The second flexible beam 22 is parallel to and spaced apart from the first flexible beam 20. A third flexible beam 23 of polyvinyl chloride pipe is attached at the ends thereof to the substantially parallel spaced apart substantially horizontal pipe sections 12 by way of the specially adapted polyvinyl chloride tee pipe fittings 21. The third flexible beam 23 is bowed upward from the ends thereof under bending stress. The Third flexible beam 23 is parallel to and spaced apart from the second flexible beam 22. A first ridge beam 24 of polyvinyl chloride pipe is attached at one end thereof at or near the apex of the bow of the first flexible beam 20 and at the other end thereof at or near the apex of the bow of the second flexible beam 22 by way of a polyvinyl chloride tee pipe fitting 26 and a polyvinyl chloride cross pipe fitting 27. A second ridge beam 25 of polyvinyl chloride pipe is attached at one end thereof at or near the apex of the bow of the third flexible beam 23 and at the other end thereof at or near the apex of the bow of the third flexible beam 23 by way of a polyvinyl chloride tee pipe fitting 28 and the polyvinyl chloride cross pipe fitting 27.

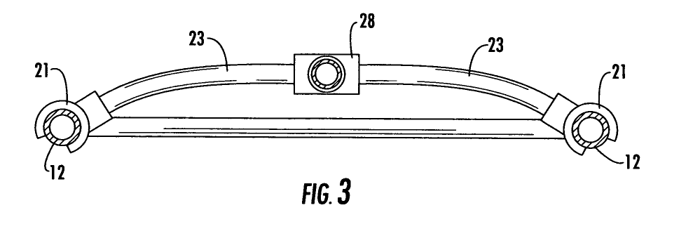

Referring now to FIG. 3, therein is shown the cross-sectional end view of the structure as indicated in FIG. 2. It will be noted that the polyvinyl chloride tee pipe fittings 21 have been modified to snap over the pipe sections 12.

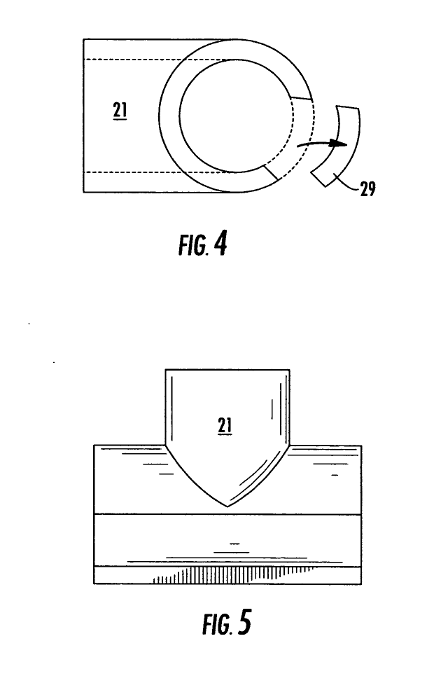

Referring now to FIG. 4, therein is shown an end view of one of the polyvinyl chloride tee pipe fittings 21 that has the portion 29 removed as shown. Referring now to FIG. 5, therein is shown a front view of the polyvinyl chloride tee pipe fitting 21 of FIG. 4.

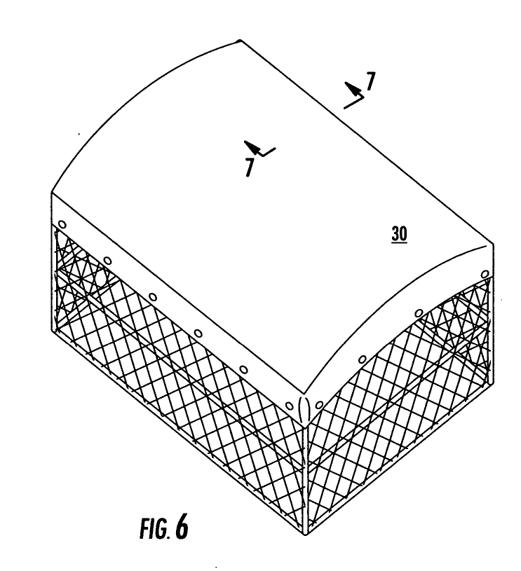

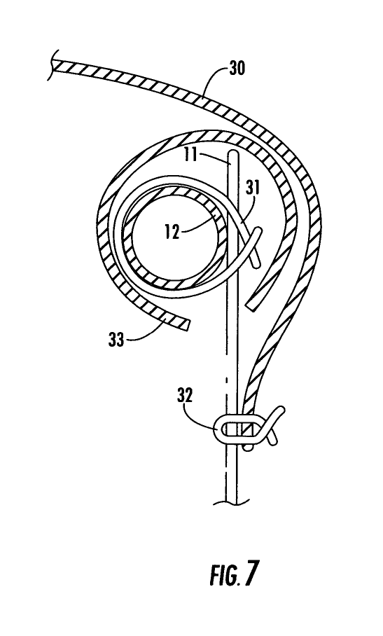

Referring now to FIG. 6, a perspective view of the dog kennel of FIG. 1 provided with the flexible beam structure of FIG. 2 supporting a tarp 30. Referring now to FIG. 7, therein is shown a cross-sectional view, as indicated in FIG. 6, of the tarp 30 draped over the top of the chain link fencing 11 and secured thereto by tied cord 32. The chain link fencing 11 is attached to the pipe 12 by a length of twisted wire 31. In order to prevent chafing of the tarp 30 by the top of the chain link fencing 11, a length of silted polyethylene drain pipe 33 is preferably positioned over the top of the chain link fencing 11 and around the pipe 12 as shown.

Referring again to FIG. 2, it should be understood that although the fittings 26, 27 and 28 may be demountable from the flexible beams 20, 22 and 23, for the purposes of defining the term “flexible beam”, the fittings 26, 27 and 28 are an integral part of the flexible beams 20, 22 and 23. And, preferably, the fittings 21, 26, 27 and 28 are glued to the beams 20, 22, 23, 24 and 25 using polyvinyl chloride pipe fitting cement. The pipe 14 can be replaced with a rope or cord when a flexible beam is used in the center or central portions of the kennel. Of course, smaller kennels may require only two flexible beams and longer kennels may require more than three flexible beams.

Polyvinyl chloride pipe is the preferred material for the flexible beams of the instant invention. However, any flexible beam material can be used in the instant invention such as shock cord tent poles or fiberglass tent poles. An important advantage of the flexible beams of the instant invention being bowed upwards from their ends under bending stress is the toughness of the resulting structure under windy conditions. The structure can flex somewhat but retains significant strength despite its relatively light weight. The snap-on pipe fittings 21 of the above discussion are highly preferred as aiding in the facile construction of the instant invention. However, any suitable means can be used to attach the flexible beams of the instant invention to the horizontal pipe at or near the top walls of a kennel. Similarly, any suitable means can be used to attach the ridge beam to the bowed flexible beams.

In conclusion, it is readily apparent that although the invention has been primarily described above in relation with its preferred embodiments, it should be understood that the instant invention is not limited thereby but is intended to cover all alternatives, modifications and equivalents that are included within the scope of the invention as defined by the following claims.

What is claimed is:

1. An improved roof or canopy system for a dog kennel or the like, the kennel comprising substantially parallel spaced apart walls, the kennel comprising substantially parallel spaced apart substantially horizontal pipe sections at or near the top of the spaced apart walls, wherein the improvement comprises: (a) a first flexible beam attached at the ends thereof to the substantially parallel spaced apart substantially horizontal pipe sections, the first flexible beam being bowed upward from the ends thereof under bending stress; (b) at least a second flexible beam attached at the ends thereof to the substantially parallel spaced apart substantially horizontal pipe sections, the second flexible beam being bowed upward from the ends thereof under bending stress, the second flexible beam being substantially parallel to and spaced apart from the first flexible beam; and (c) a ridge beam attached at one end thereof at or near the apex of the bow of the first flexible beam and at the other end thereof at or near the apex of the bow of the second flexible beam.

2. The improved roof or canopy system of claim 1, further comprising a tarp draped over the ridge beam and the first and second flexible beams to form a canopy for the kennel.

3. The improved roof or canopy system of claim 1, wherein the ridge beam and the first and second flexible beams consist of lengths of polyvinyl chloride pipe.

4. The improved roof or canopy system of claim 2, wherein the ridge beam and the first and second flexible beams consist of lengths of polyvinyl chloride pipe.

5. The improved roof or canopy system of claim 3, wherein the ridge beam is attached at one end thereof to the first flexible beam by a polyvinyl chloride tee or cross pipe fitting.

6. The improved roof or canopy system of claim 4, wherein the ridge beam is attached at one end thereof to the first flexible beam by a polyvinyl chloride tee or cross pipe fitting.

7. The improved roof or canopy system of claim 3, wherein the ends of the first flexible beam are attached to the substantially parallel spaced apart substantially horizontal pipe sections using polyvinyl chloride tee pipe fittings that have been cut away to snap over the substantially parallel spaced apart substantially horizontal pipe sections.

8. The improved roof or canopy system of claim 4, wherein the ends of the first flexible beam are attached to the substantially parallel spaced apart substantially horizontal pipe sections using polyvinyl chloride tee pipe fittings that have been cut away to snap over the substantially parallel spaced apart substantially horizontal pipe sections.

9. The improved roof or canopy system of claim 5, wherein the ends of the first flexible beam are attached to the substantially parallel spaced apart substantially horizontal pipe sections using polyvinyl chloride tee pipe fittings that have been cut away to snap over the substantially parallel spaced apart substantially horizontal pipe sections.

10. The improved roof or canopy system of claim 6, wherein the ends of the first flexible beam are attached to the substantially parallel spaced apart substantially horizontal pipe sections using polyvinyl chloride tee pipe fittings that have been cut away to snap over the substantially parallel spaced apart substantially horizontal pipe sections.
